(19) United States
(12) Patent Application Publication
(10) Pub. No.: US 2007/0184240 A1
(43) Pub. Date: Aug. 9, 2007

(54) Method of manufacturing plugged honeycomb structure and plugged honeycomb structure

(75) Inventor: Yukihito Ichikawa, Nagoya-city (JP)

Correspondence Address: OLIFF & BERRIDGE, PLC, P.O. BOX 19928, ALEXANDRIA, VA, 22320, US

(73) Assignee: NGK INSULATORS, LTD., NAGOYA-CITY (JP)

(21) Appl. No.: 11/657,035

(22) Filed: Jan. 24, 2007

(30) Foreign Application Priority Data
Feb. 3, 2006 (JP) 2006-026939

(51) Int. Cl. B32B 3/12; B01D 50/00; B01D 53/34

(52) U.S. Cl. 428/116; 428/117; 422/180; 422/177

(57) ABSTRACT

There is provided a method for manufacturing a plugged honeycomb structure having a honeycomb structure where a plurality of cells extending between two opening ends are defined by porous partition walls and plugged portions disposed so as to plug one of the two opening ends of each of the cells. In this manufacturing method, after a plugging mixed material is filled into opening end portions of all the cells of the honeycomb structure, the plugging mixed material filled into the opening end portions of cells which should not be plugged is removed and penetrated to open the end portions of the cells which should not be plugged. According to this manufacturing method, a plugged honeycomb structure having no defects can be manufactured at low costs for a short time without restriction on operation circumstances with less industrial waste.

### BACKGROUND OF THE INVENTION AND RELATED ART STATEMENT

The present invention relates to a plugged honeycomb structure used as a filter for filtrating particulate matter, such as a diesel particulate filter, or as a catalyst carrier for purifying harmful components such as HC, NOₓ, and CO in exhaust gas by carrying a catalyst component on a surface of pores of porous partition walls defining cells and passing exhaust gas through the pores of the partition walls.

Since, in the exhaust gas exhausted from an internal combustion engine of a diesel engine or the like, a large amount of particulate matter having carbon which causes environmental pollution as the main component is contained, it is general that a filter for trapping (filtrating) particulate matter is mounted in an exhaust gas system thereof.

In a filter used for such a purpose, as shown in FIGS. 13(a) and 13(b), there is generally used a plugged honeycomb structure 1 having a honeycomb structure 2 where a plurality of cells 9 extending between two end faces are separated and formed by porous partition walls 7 and plugged portions 11 disposed so as to plug one of the two opening ends of each of the cells 9 and to form a checkerwise pattern on each of the end faces complementarily between one end face and the other end face of the honeycomb structure 2.

Exhaust gas flows into the inside from one end face 3 of a filter constituted by such a plugged honeycomb structure 1, and after particulate matter and the like contained in the gas are removed, it flows out from the other end face 5. Specifically, exhaust gas flows into the cells 9b whose end portions are not plugged on one end face 3 and are plugged on the other end face 5 in the first place, passes through the porous partition walls 7, moves into the cells 9a whose end portions are plugged on the end face 3 and are not plugged on the other end face 5, and is discharged from the cells 9a. At this time, the partition walls 7 function as a filtration layer, and particulate matter in the gas is trapped by the partition walls 7 and accumulates on the partition walls 7.

As a method for manufacturing a plugged honeycomb structure as described above, there is known a method where an adhesive sheet or the like is blocked on one end face of a formed honeycomb body, holes are made in portions corresponding to cells to be plugged (plugged cells) of the adhesive sheet or the like by laser processing using image processing to prepare a mask, the end face having the mask blocked thereon of the formed honeycomb body is immersed in slurry for plugging to fill the slurry into the cells to be plugged of the formed honeycomb body to form plugged portions, the same process is performed with respect to the other end face of the formed honeycomb body, followed by drying and firing to obtain a plugged honeycomb structure (see, e.g., Patent Document 1).

As another manufacturing method, there has been proposed a method where through-holes are formed in an undried formed sheet-shaped green body of a ceramic material in a checkerwise pattern, and the formed sheet-shaped green body is bonded to an end face of a honeycomb-shaped dried body under pressure, followed by integrally firing to obtain a plugged honeycomb structure (see, e.g., Patent Document 2).

By the way, recently, an attempt has been made to utilize such a plugged honeycomb structure as a catalyst for purifying harmful components such as HC, NOₓ, and CO in exhaust gas by carrying a catalyst component on a surface of pores in the porous partition walls defining the cells and passing exhaust gas flowing into the honeycomb structure through the pores of the partition walls (such a catalyst is hereinbelow referred to as a “wall-flow type catalyst”) other than a filter for trapping particulate matter as described above.

According to expansion of usage of such a plugged honeycomb structure, it is expected that a demand for a plugged honeycomb structure will increase much more in the future. In the case of trying to mass-produce plugged honeycomb structures by employing the manufacturing method described in the Patent Document 1, it is required to solve the problems of (i) requiring steps of bonding an adhesive sheet, image processing, making holes, and peeling the adhesive sheet with respect to each of both the end faces of each honeycomb structure, which generates a large amount of industrial waste of peeled adhesive sheets after being used, in addition to requirement of much time to be spent on production of a mask, etc., and (ii) causing rise in production cost because an adhesive sheet is relatively expensive and requiring to perform bonding operation in clean circumstances since the sheet hates dirt and dust, which restricts operation circumstances. That is, though the above-mentioned conventional manufacturing method is effective in manufacturing a relatively small number of plugged honeycomb structures, a sufficient satisfaction cannot be derived from the conventional manufacturing method from the viewpoint of mass-production adaptability.

In addition, the manufacturing method described in Patent Document 2 has problems of easily having a crack in the sheet or peeling of the sheet due to a difference in drying shrinkage between a honeycomb-shaped dried body and an undried formed sheet-shaped green body and hard plugging of the cells to be plugged among the cells located in the outermost periphery of the honeycomb structure.

[Patent Document 1] JP-A-2001-300922

[Patent Document 2] JP-A-2002-159811

### SUMMARY OF THE INVENTION

The present invention has been made in view of the problems of prior art as described above, and the aim of the present invention is to provide a method for manufacturing a plugged honeycomb structure, the method being suitable for mass-production, particularly, without restriction on operation circumstances, capable of manufacturing a plugged honeycomb structure without any defect at low costs for a short time and capable of reducing an amount of industrial waste.

In order to achieve the above objective, according to the present invention, there are provided the following methods for manufacturing plugged honeycomb structures and the following plugged honeycomb structures.

[1] A method for manufacturing a plugged honeycomb structure having a honeycomb structure where a plurality of cells extending between two opening ends are defined by porous partition walls and plugged portions disposed so as to plug one of the two opening ends of each of the cells, wherein, after a plugging mixed material is filled into opening end portions of all the cells of the honeycomb structure, the plugging mixed material filled into the opening end portions of cells which should not be plugged is removed and penetrated to open the end portions of the cells which should not be plugged.

[2] A method for manufacturing a plugged honeycomb structure according to the above [1], wherein an operation of removing and penetrating the plugging mixed material filled into the opening end portions of cells which should not be plugged is performed independently on each of the end faces of the honeycomb structure.

[3] A method for manufacturing a plugged honeycomb structure according to the above [1], wherein the operation of removing and penetrating the plugging mixed material filled into the opening end portions of cells which should not be plugged is performed simultaneously on both the end faces of the honeycomb structure.

[4] A method for manufacturing a plugged honeycomb structure according to any one of the above [1] to [3], wherein, after a plugging mixed material is filled into opening end portions of all the cells of the honeycomb structures, a hole-making jig having a flat upper surface and pins disposed so as to correspond to positions of the cells which should not be plugged on an end face of the honeycomb structure is positioned so that the end portions of the cells which should not be plugged of the honeycomb structure match the positions of the pins of the hole-making jig, and the end face is pressed against the upper surface of the hole-making jig to remove and penetrate the plugging mixed material filled into the opening end portions of the cells which should not be plugged with the pins.

[5] A method for manufacturing a plugged honeycomb structure according to the above [4], wherein the pins are movable on the hole-making jig, a photograph of an end face of the honeycomb structure is taken in advance and subjected to image processing to recognize positional coordinates of the cells which should not be plugged, the pins are moved based on data of the positional coordinates so that positions of the pins match positions of the cells which should not be plugged, and then the end face of the honeycomb structure is pressed against the upper surface of the hole-making jig.

[6] A method for manufacturing a plugged honeycomb structure according to any one of the above [1] to [3], wherein, after a plugging mixed material is filled into opening end portions of all the cells of the honeycomb structures, the plugging mixed material filled into the opening end portions of cells which should not be plugged is removed and penetrated by laser irradiation.

[7] A method for manufacturing a plugged honeycomb structure according to the above [1], wherein, after a plugging mixed material is filled into opening end portions of all the cells of the honeycomb structures, the plugging mixed material filled into the opening end portions of cells which should not be plugged is removed and penetrated by sweeping away with pressurized fluid to open the end portions of the cells which should not be plugged.

[8] A method for manufacturing a plugged honeycomb structure having a honeycomb structure where a plurality of cells extending between two opening ends are defined by porous partition walls and plugged portions disposed so as to plug one of the two opening ends of each of the cells, wherein, after a plugging mixed material is filled into opening end portions of all the cells on one end face of the honeycomb structure, the plugging mixed material filled into the opening end portions of cells which should not be plugged is removed and penetrated by sweeping away with pressurized fluid to open the end portions of the cells which should not be plugged, and then the plugging mixed material is filled into the opening end portions of the cells on the other end face of the honeycomb structure which should be plugged by vacuum suction.

[9] A plugged honeycomb structure manufactured by a method according to any one of the above [1] to [8].

[10] A plugged honeycomb structure having a honeycomb structure where a plurality of cells extending between two opening ends are defined by porous partition walls and plugged portions disposed so as to plug one of the two opening ends of each of the cells, wherein the same material as a material for the plugged portions adheres to an inner peripheral face of an opening end on an unplugged side of each of the cells.

[11] A plugged honeycomb structure according to the above [10], wherein the same material as a material for plugged portions further adheres to an end face of the honeycomb structure.

[12] A plugged honeycomb structure according to the above [10] or [11], wherein cells which should be plugged among the cells locating in an outermost periphery of the honeycomb structure are entirely plugged with the plugged portions.

[13] A plugged honeycomb structure according to any one of the above [10] to [12], wherein the plugged honeycomb structure is manufactured by a method according to the above [4], and a protrusion or a groove functioning as a standard for positioning is formed in an outer periphery thereof.

[14] A plugged honeycomb structure according to any one of the above [9] to [13], wherein the cells are plugged with the plugged portions on only one end face of the honeycomb structure.

A method for manufacturing a plugged honeycomb structure of the present invention is a method suitable for mass-production, where, without restriction on operation circumstances, a plugged honeycomb structure without any defect can be manufactured at low costs for a short time with reducing the amount of industrial waste. In addition, a plugged honeycomb structure of the present invention can be manufactured at low costs for a short time without restriction on operation circumstances by the above manufacturing method of the present invention and is suitable for mass-production with reducing the amount of industrial waste.

### BRIEF DESCRIPTION OF THE DRAWINGS

FIG. 1 is a schematic view showing an example of an embodiment of a manufacturing method of the present invention.

FIG. 2 is a schematic view showing an example of an embodiment of a manufacturing method of the present invention.

FIG. 3 is a schematic view showing an example of an embodiment of a manufacturing method of the present invention.

FIG. 4 is a schematic view showing an example of an embodiment of a manufacturing method of the present invention.

FIG. 5 is a schematic view showing an example of an embodiment of a manufacturing method of the present invention.

FIG. 6 is a schematic view showing an example of an embodiment of a manufacturing method of the present invention.

FIG. 7 is a schematic view showing an example of an embodiment of a manufacturing method of the present invention.

FIG. 8 is a schematic view showing an example of an embodiment of a manufacturing method of the present invention.

FIG. 9 is a schematic view showing an example of an embodiment of a manufacturing method of the present invention.

FIG. 10 is a schematic view showing a part of a plugged honeycomb structure of the present invention.

FIG. 11 is a schematic view showing a part of a conventional plugged honeycomb structure.

FIG. 12 is a schematic view showing an example of an embodiment of a plugged honeycomb structure of the present invention.

FIGS. 13(a) and 13(b) are schematic views each showing a basic structure of a plugged honeycomb structure. FIG. 13(a) is a plan view from an end face side, and FIG. 13(b) is a cross-sectional view.

### DESCRIPTION OF REFERENCE NUMERALS

1: plugged honeycomb structure, 2: honeycomb structure, 3: end face, 5: end face, 7: partition wall, 9: cell, 11: plugged portion, 19: cell, 21: container, 23: cover, 30: hole-making jig, 31: pin, 32: pressurized fluid-introducing jig, 33: spout nozzle, 34: vacuum suction jig, 35: suction nozzle, 40: sealing material, 50: plugging mixed material, 51: remaining plugging mixed material, 60: protrusion

### DETAILED DESCRIPTION OF THE INVENTION

As described above, a method for manufacturing a plugged honeycomb structure of the present invention is a method for manufacturing a plugged honeycomb structure having a honeycomb structure where a plurality of cells extending between two opening ends are defined by porous partition walls and plugged portions disposed so as to plug one of the two opening ends of each of the cells, the method being mainly characterized in that, after a plugging mixed material is filled into opening end portions of all the cells of the honeycomb structure, the plugging mixed material filled into the opening end portions of cells which should not be plugged is removed and penetrated to open the end portions of the cells which should not be plugged.

Incidentally, a “plugging mixed material” in the present invention means a material where a dispersant such as water and an additive such as a binder are added to a ceramic powder to give flowability. A material in the form of slurry is particularly preferable from the viewpoint of easiness in filling into opening end portions of cells and matching of the material with partition walls after the filling. However, the material may be in the form of clay or powder hardly containing a liquid component as long as it is possible to be filled into opening end portions of cells.

Typical embodiments of the present invention will hereinbelow be described concretely with referring to drawings. However, the present invention is by no means limited to the following embodiments, and it should be understood that changes, improvements, or the like, of a design may suitably be added in a range of not deviating from the gist of the present invention on the basis of general knowledge of those skilled in the art.

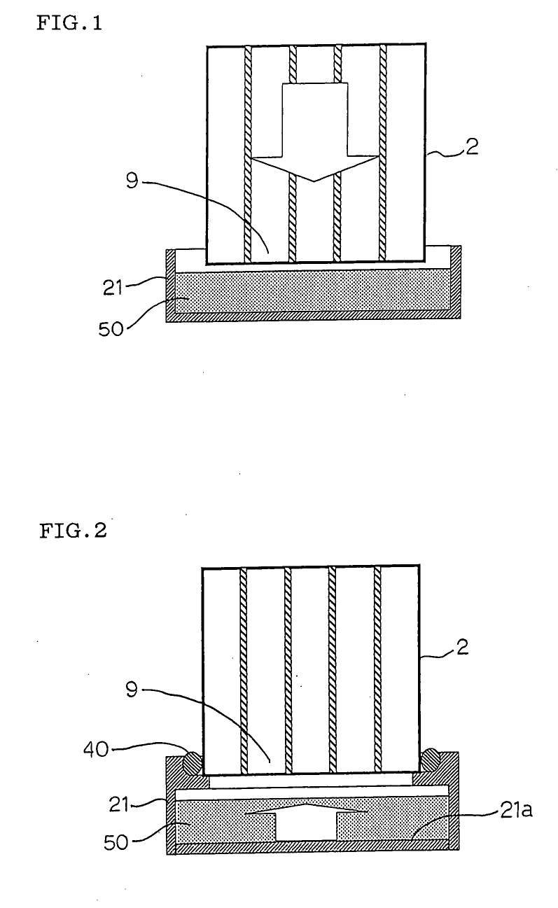

FIGS. 1 to 5 are schematic views showing an example of an embodiment of a manufacturing method of the present invention. In a method for manufacturing a plugged honeycomb structure of the present invention, in the first place, a plugging mixed material is filled into the opening end portions of all the cells of the honeycomb structure. As a specific method of filling, as shown in FIG. 1, a method where, with pressing an end face of a honeycomb structure 2 against the liquid surface of a slurried plugging mixed material 50 contained in the container 21, the end face of the honeycomb structure 2 is immersed in the plugging mixed material 50 to fill the plugging mixed material 50 into the opening end portions of the cells 9 by injection with pressure is preferable because it is simple and it can fill entirely.

In addition, as another possible method, as shown in FIG. 2, an end portion of the honeycomb structure 2 is engaged with an opening portion in the top portion of the container 21 containing the plugging mixed material 50, a gap at the engaged portion is sealed with a sealing material 40, and the plugging mixed material 50 in the container 21 is filled in opening end portions of the cells 9 in this state by injection with pressure or sucking. In the case of injection with pressure, there may be employed, for example, a method where the bottom face 21a of the container 21 is made vertically movable with a piston mechanism or the like, and the volume of the container 21 is reduced to be smaller than the volume of the plugging mixed material 50 contained in the container 21 by moving the bottom face 21a upward upon filling to press the plugging mixed material 50 into the end portions of the cells 9 from the container 21. In addition, in the case of suction, suction is performed with a pump or the like from an end portion opposite to the end portion which is engaged with the opening portion of the container 21 of the honeycomb structure 2 to fill the plugging mixed material 50 contained in the container 21 into the opening end portions of the cells 9 by suction.

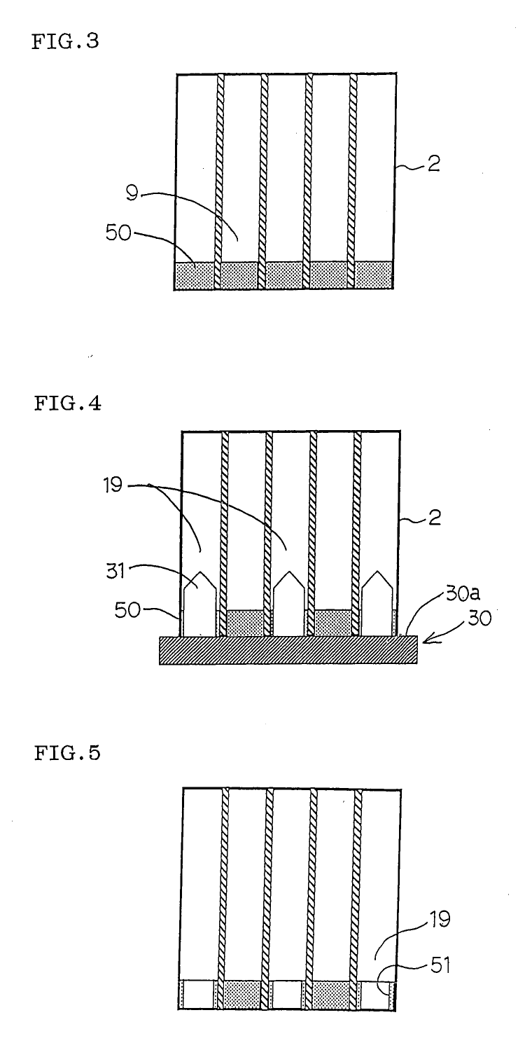

With such a method, as shown in FIG. 3, after the plugging mixed material 50 is filled into the opening end portions of all the cells 9 of the honeycomb structure 2, the plugging mixed material filled into the opening end portions of cells which should not be plugged is removed and penetrated to open the end portions of the cells which should not be plugged. FIG. 4 shows an example of using a hole-making jig 30 as a means for removing and penetrating the plugging mixed material 50 filled into opening end portions of cells 19 which should not be plugged. As shown in FIG. 4, the hole-making jig 30 used here has a plurality of pins 31 set up a flat upper surface 30 aso as to correspond to positions of the cells 19 which should not be plugged on an end face of the honeycomb structure 2.

The honeycomb structure 2 and the hole-making jig 30 are positioned so that the end portions of the cells 19 which should not be plugged of the honeycomb structure matches the positions of the pins 31 of the hole-making jig 30. Then, as shown in FIG. 4, an end face of the honeycomb structure 2 is pressed against the upper surface 30a of the hole-making jig 30 to remove and penetrate the plugging mixed material 50 filled into the opening end portions of the cells 19 which should not be plugged with pins 31. Thus, as shown in FIG. 5, the end portions of the cells 19 which should not be plugged can be opened.

Incidentally, it is preferable that a protrusion or a groove functioning as a standard for positioning is formed in an outer periphery of the honeycomb structure 2 and in the hole-making jig 30 for easy positioning. This is suitable for the case of automating a positioning operation, and positioning can be controlled by recognizing positional coordinates of the protrusion or the groove using image processing or the like.

When a cell of the honeycomb structure is deformed, a position of each cell of the honeycomb structure is deviated from a designed position. Therefore, it is difficult to accurately perform the above penetration and removal depending on the extent of deformation of the cell. This is remarkable in the case that the honeycomb structure has a relatively high cell density and in the case that the honeycomb structure has relatively large external dimensions. In such cases, the pins 31 are disposed to be movable on the upper surface 30a of the hole-making jig 30, a photograph of an end face of the honeycomb structure 2 is taken in advance and subjected to image processing to recognize positional coordinates of the cells 19 which should not be plugged, the pins 31 are moved based on data of the positional coordinates so that positions of the pins 31 match positions of the cells 19 which should not be plugged, and the end face of the honeycomb structure 2 is pressed against the upper surface 30a of the hole-making jig 30. Thus, the plugging mixed material 50 filled in the opening end portions of the cells 19 which should not be plugged can be penetrated and removed with the pins 31 more adequately.

Though a plurality of pins 31 are set up on the upper surface 30a of the hole-making jig 30 in the example shown in FIG. 4, a hole-making jig having only one pin may be used. When a hole-making jig having only one pin is used, the hole-making jig is moved at high speed like a sewing machine based on data of the above-mentioned positional coordinates to perform the above penetration and removal in cells one by one. When a hole-making jig having a plurality of pins is used, the penetration and removal may be performed simultaneously in all the cells which should not be plugged on the whole end face of the honeycomb structure. Alternatively, the penetration and removal may be performed with hole-making jigs by each of a plurality of blocks into which the end face of the honeycomb structure is divided. Further, the penetration and removal operation on the whole end face can be performed at high speed by dividing the end face into a plurality of blocks to perform the penetration and removal with independent hole-making jigs (hole-making jigs each having only one pin or a plurality of pins) by each block. As a means for moving a pin on a hole-making jig, conventionally known various kinds of actuators may be employed. In the case that movement of the pin is very little, a piezoelectric element may be used.

In addition, it is generally necessary to perform the operation of penetrating the plugging mixed material 50 filled into the opening end portions of the cells 19 which should not be plugged with a pin 31 of a hole-making jig 30 on both the end face sides of the honeycomb structure. However, the operation may be performed independently in order on each of the end faces of the honeycomb structure. Alternatively, in the first place, the plugging mixed material may filled into both of the two opening ends of each of all the cells, followed by the penetration operation simultaneously on both the end face sides of a honeycomb structure in such a manner that the honeycomb structure is held between two hole-making jigs. Thus, on both the end face sides of the honeycomb structure, after end portions of cells which should not be plugged are opened, a honeycomb structure is dried and/or fired as necessary to obtain a plugged honeycomb structure.

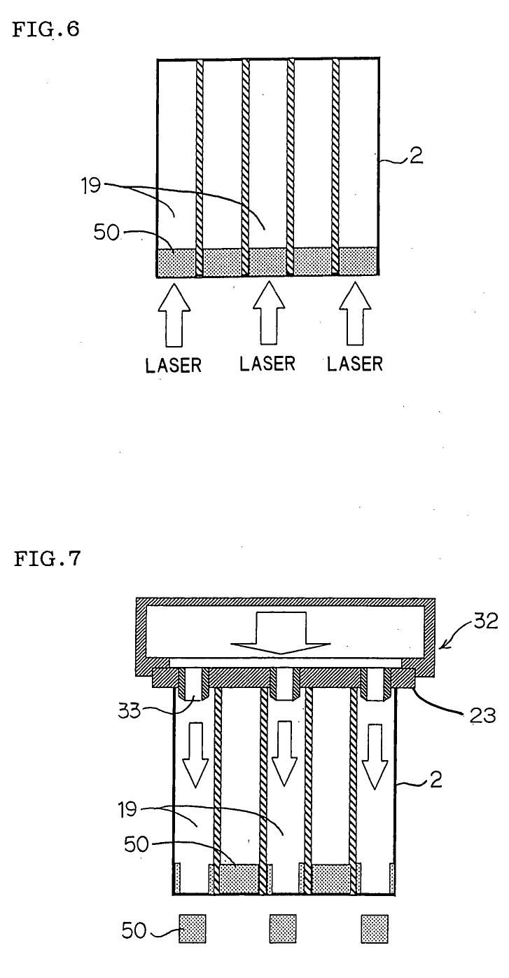

FIG. 6 shows an example of using a laser as a means for removing and penetrating the plugging mixed material 50 filled into opening end portions of cells 19 which should not be plugged. In this example, as shown in FIG. 3, after the plugging mixed material 50 is filled into the opening end portions of all the cells 9 of the honeycomb structure 2, the plugging mixed material 50 is removed and penetrated by laser irradiation to open the end portions of the cells 19 which should not be plugged as shown in FIG. 5.

In such a method using a laser, the plugging mixed material melts by laser irradiation and is vitrified to become a sphere glass body, which sometimes remains inside a cell. Therefore, it is preferable to remove the vitrified glass body by compressed air, sand blasting, or the like, after the penetration and removal operation by laser irradiation as necessary. Though there is no particular limitation on kind of a laser used for laser irradiation, a carbonic acid gas laser is preferable.

FIG. 7 shows an example of using pressurized fluid as a means for removing and penetrating the plugging mixed material 50 filled into opening end portions of cells 19 which should not be plugged. In this example, after the plugging mixed material 50 is filled in the opening end portions of all the cells 9 of the honeycomb structure 2 as FIG. 3, a pressurized fluid-introducing jig 32 is fixed on an end face on the side opposite to the side where the plugging mixed material 50 is filled of the honeycomb structure 2, and the pressurized fluid is introduced into the cells 19 which should not be plugged via the pressurized fluid-introducing jig 32 to remove and penetrate the plugging mixed material 50 filled into the opening end portions of the cells 19 by sweeping away with pressurized fluid. Thus, as shown in FIG. 5, end portions of the cells 19 which should not be plugged are opened.

The pressurized fluid-introducing jig 32 is a container-like jig having spout nozzles 33 disposed so as to correspond to positions of cells 19 which should not be plugged. When pressurized fluid is sent in the jig, the pressurized fluid is introduced selectively into cells 19 which should not be plugged via the nozzles 33. As a pressurized fluid, compressed air or the like can suitably be used.

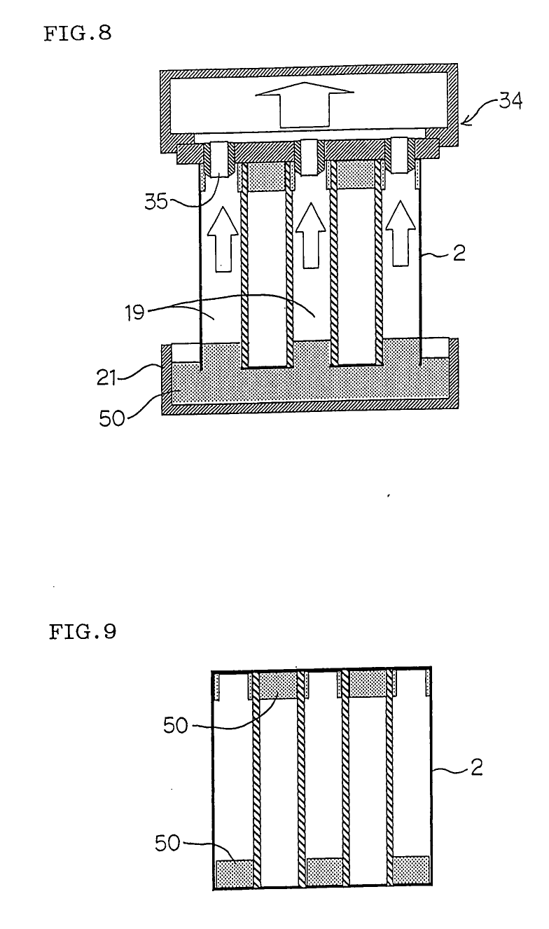

Incidentally, in the case of manufacturing a plugged honeycomb structure where opening end portions of predetermined cells are plugged on both the end faces of the honeycomb structure in a method of using such pressurized fluid, after the penetration and removal operation is performed with pressurized fluid as described above on one end face of the honeycomb structure in the first place, the plugging mixed material is filled into opening end portions of cells which should be plugged by vacuum suction on the other end face of the honeycomb structure. Specifically, as shown in FIG. 8, the other end face (end face on the side where opening end portions are opened opposite to the opening end portions on the side where the penetration and removal operation with pressuring fluid was applied) of the honeycomb structure is immersed in the plugging mixed material 50 contained in the container 21 and subjected to vacuum suction from the opposite end face to fill the plugging mixed material 50 into opening end portions of cells 19 which should be plugged on the other end face side.

Here, “cells which should be plugged” where the plugging mixed material is filled into opening end portions thereof are the same cells 19 as “cells which should not be plugged” where the penetration and removal operation with pressurized fluid is performed. That is, each of the cells is plugged basically in one of the two end portions, whereby the cells which should be plugged in the opening portions on one end face of the honeycomb structure are the cells which should not be plugged in the opening portions on the other end face.

When the above vacuum suction is conducted, it is preferable to use a vacuum suction jig 34 as shown in FIG. 8. The vacuum suction jig 34 is a container-like jig having suction nozzles 35 disposed so as to correspond with positions of cells 19 which should not be plugged and where the penetration and removal operation was performed before (cells to be plugged by filling the plugging mixed material by the suction of this time). When the vacuum suction is performed with respect to the inside thereof, pressure inside the cells 19 is lowered due to suction through the suction nozzles 35, and the plugging mixed material 50 is sucked up and filled into opening end portions of the cells 19. Thus, as shown in FIG. 9, a plugged honeycomb structure where cells are plugged on both the end faces of the honeycomb structure 2 can be obtained. Incidentally, a surplus plugging mixed material adhering to an end face of the honeycomb structure by the immersion in the plugging mixed material may be removed after drying by blasting, buffing, or the like, as necessary.

As described above, in the case that the plugging mixed material filled into opening end portions of the cells which should not be plugged is penetrated and removed by using a laser or pressurized fluid, the plugging mixed material has a depth of filling of preferably 3 mm or less, more preferably 1 mm or less because the penetration and removal is difficult when the depth of filling (length of the plugging mixed material filled in the cell-axial direction) of the plugging mixed material is too deep. Incidentally, the plugging mixed material in a conventional plugged honeycomb structure has a depth of filling of about 3 to 15 mm.

In a plugged honeycomb structure manufactured by a manufacturing method of the present invention, as shown in FIG. 5, a part of the plugging mixed material filled in the first place remains in end portions of cells 19 which should not be plugged and which are opened by the above penetration and removal operation in a state of adhering in the inner peripheral faces of the cells. However, if the remaining plugging mixed material 51 does not make opening portions of the cells 19 which should not be plugged extremely narrow and adheres to the inner peripheral faces of the cells 19 to form a thin layer, remarkable performance deterioration is not caused even if the structure is used as a filter for filtrating particulate matter, a carrier for wall-flow type catalyst, or the like. Incidentally, in the case of performing the above penetration and removal operation using a hole-making jig, as the difference between a cross-sectional size of a pin of the hole-making jig and a cross-sectional size of a cell of the honeycomb structure becomes smaller, the remaining plugging mixed material can be reduced more.

In a honeycomb structure (honeycomb structure before plugging) used for a manufacturing method of the present invention, a plurality of cells extending between two end faces are defined by porous partition walls. Though there is no particular limitation on a material constituting the honeycomb structure, it is required that the partition walls are porous. Therefore, generally, a material of ceramic (e.g., cordierite) is suitably used. A shape of the honeycomb structure is not particularly limited, and various shapes such as a cylindrical shape, a quadratic prism, and a triangular prism can be employed. Regarding a cell shape of the honeycomb structure, a rectangle is the most general shape. However, polygons such as a triangle, a hexagon, and an octagon, a circle, or a combination thereof may be employed.

The honeycomb structure has a partition wall thickness of preferably 100 to 2000 μm, more preferably 200 to 1000 μm, and furthermore preferably 300 to 700 μm. This is because, when the thickness is below 100 μm, thermal shock resistance may be lowered in some cases due to insufficient strength, and, when the thickness is above 2000 μm, pressure loss tends to increase.

The honeycomb structure has a cell density of preferably 20 to 600 cells/in² (cpsi), more preferably 50 to 400 cpsi, and furthermore preferably 100 to 300 cpsi. This is because, when the cell density is below 20 cpsi, contact efficiency with exhaust gas tends to be insufficient in the case that the honeycomb structure is used as a carrier or the like for a wall-flow type catalyst, and, when the cell density is above 600 cpsi, pressure loss tends to increase. Incidentally, “cpsi” is an abbreviation of “cells per square inch”, which is a unit for expressing the number of cells per square inch. For example, 10 cpsi is approximately 1.55 cells/cm².

The honeycomb structure has a porosity of preferably 30 to 90%, more preferably 45 to 80%, and particularly preferably 50 to 70%. By the porosity of 30 to 90%, pressure loss is reduced, and heat capacity is reduced, and whereby mechanical strength as a structure can be maintained.

The honeycomb structure has an average pore size (pore diameter) of preferably 5 to 500 μm. When the average pore size is below 5 μm, pressure loss tends to rise. On the other hand, when the average pore size is above 500 μm, trapping efficiency may be lowered when the structure is used for a filter, and it is apprehended that contact area of a catalyst layer with exhaust gas cannot sufficiently be obtained in the case that the structure is used as a carrier or the like for a wall-flow type catalyst. In addition, by making the pores large, there is an influence of reduction in contact probability of a catalyst layer on the inner surface of the pores with components of exhaust gas passing through the pores.

A method for manufacturing such a honeycomb structure is not particularly limited, and the honeycomb structure can be manufactured by, for example, a method where ceramic clay whose viscosity is suitably adjusted is subjected to extrusion molding with a die having predetermined cell shape, partition wall thickness, and cell density (cell pitch), followed by drying.

The plugging mixed material can be prepared by, for example, mixing a dispersant (water or the like) with a ceramic powder. Further, as necessary, additives such as a bonding agent, a deflocculant, and a foaming resin may be added. Though a material for a ceramic powder is not particularly limited, it is preferable to use the same material as that for the honeycomb structure. As a bonding agent, poly(vinyl alcohol) or methyl cellulose can suitably be used.

A manufacturing method of the present invention does not require many steps such as bonding of an adhesive sheet on an end face of a honeycomb structure, image processing, making holes, and peeling of the adhesive sheet unlike the conventional manufacturing method and can manufacture a plugged honeycomb structure without any defect simply with less steps. In addition, since an adhesive sheet which is expensive and requires bonding operation in clean circumstances is not required, production costs can be suppressed, there is no restriction on operation circumstances, and industrial waste can be reduced.

A plugged honeycomb structure of the present invention is a plugged honeycomb structure manufactured by a manufacturing method of the present invention described above. The plugged honeycomb structure has a honeycomb structure where a plurality of cells extending between two opening ends are defined by porous partition walls and plugged portions disposed so as to plug one of the two opening ends of each of the cells. The plugged honeycomb structure is characterized in that the same material as a material for the plugged portions adheres to an inner peripheral face of an opening end on an unplugged side of each of the cells.

Though the same material as a material for the plugged portions adhering to an inner peripheral face of an opening end on an unplugged side of each of the cells does not have any specific function in this plugged honeycomb structure, such a structure can be manufactured by the above-mentioned method for manufacturing the present invention, therefore having the advantage of being suitable for mass-production because it can be produced at low costs for a short time without restriction on operation circumstances with reducing amount of industrial waste. Incidentally, in the case that such a plugged honeycomb structure is manufactured in the above manufacturing method of the present invention, the same material as a material for the plugged portions sometimes adheres also to an end face of the honeycomb structure. When the adhering material has a higher density or a higher strength than the honeycomb structure, the end face of the honeycomb structure is strengthened, and an effect of suppressing erosion on the end face of the honeycomb structure due to a high-speed particulate in exhaust gas when the honeycomb structure is used as a carrier for a wall-flow type catalyst or the like.

In a plugged honeycomb structure of the present invention, it is preferable that cells to be plugged among the cells locating in the outermost periphery of the honeycomb structure are entirely plugged with the plugged portions. Such a honeycomb structure can be manufactured by the manufacturing method of the present invention.

In the case that, after a peripheral portion of a honeycomb structure prepared by extrusion molding is removed by machining, coating is performed in the outer peripheral portion in order to form a new outer wall as described in JP-A-5-269388, it is not necessary to plug the cells in the outermost peripheral portion since the outermost peripheral portion of the honeycomb structure prepared by extrusion molding is removed by machining, and therefore, the range to be removed by machining, for example, the part for two or three cells from the outer periphery toward inside does not need plugging over the all surroundings. However, in the case that the outer peripheral portion of a honeycomb structure whose outer wall is integrally formed by extrusion molding is not removed by machining to be supplied as a product with the original outer wall, it is preferable to plug the cells in the outermost peripheral portion. In a conventional filter structure, an outer peripheral portion of each of the end faces of the honeycomb structure is held with a ring-shaped member simultaneously with wrapping a side face of the honeycomb structure with a holding material to hold the honeycomb structure in a cylindrical container lest the honeycomb structure should vibrate in a direction of cell passages upon practical use. In such a case, since the cells in the outermost peripheral portion of the honeycomb structure are blocked with a ring-shaped member even without plugging, it does not practically have a problem of trapping performance as a filter. However, nowadays, the honeycomb structure has a structure where the outer peripheral portion of each of the end faces is not held with a ring-shaped member so that an exhaust gas inflow area is increased and that pressure loss is planed to be reduced. According to this structure, plugging of the cells in the outermost peripheral portion is required.

In the case of manufacturing a plugged honeycomb structure having plugged portions disposed in a checkerwise pattern in each of the end faces thereof by a method described in the Patent Document 2 (JP-A-2002-159811), i.e., a method where an undried formed sheet-shaped green body having through-holes formed in a checkerwise pattern is applied on an end surface of a honeycomb dried body under pressure and subjected to integrally firing, a plugged honeycomb structure where the cell to be plugged (the cells surrounded by the dotted lines) among the cells locating in the outermost periphery of the honeycomb structure may not be plugged or may incompletely be plugged as shown in FIG. 11 is prone to be obtained. In the case that such a plugged honeycomb structure is used as it is for, for example, a filter for filtrating and removing particulate matter, a trouble of discharging a part of particulate matter without being filtrated etc. Therefore, it is necessary to subject the honeycomb structure to a treatment of covering opening portions of the cells locating in the outermost periphery with a ring-shaped member by attaching a ring-shaped member on an end face of the honeycomb structure as described above, etc. In this case, the cells locating in the outermost periphery do not play a role as a filter or the like, and an effective area is reduced for the portions.

On the other hand, in a manufacturing method of the present invention, since a plugging mixed material is filled into the opening end portions of all the cells including the cells locating in the outermost peripheral portion of the honeycomb structure in advance, followed by selectively opening end portions of cells which should not be plugged, unplugging or incomplete plugging of cells which should be plugged in the outermost peripheral portion of the honeycomb structure is not caused.

In addition, in a method where an adhesive sheet having holes is used as a mask as the method described in the above Patent Document 1 (JP-A-2001-300922), since it is difficult to subject the adhesive sheet to a process of making holes in a portion corresponding to incomplete cells in the outermost peripheral portion of a honeycomb structure (cells lacking a part in shape with respect to other cells locating in a portion other than the outermost peripheral portion of the honeycomb structure), it is difficult to entirely fill the plugging mixed material into the incomplete cells. However, in a manufacturing method of the present invention, it is possible to entirely fill the plugging mixed material even into the incomplete cells locating in the outermost peripheral portion of a honeycomb structure. In addition, in a method described in the above Patent Document 2, a face where a formed sheet-shaped green body is joined with a honeycomb-shaped dried body is an end portion of partition walls defining the cells, and the joint face is small. Therefore, when plugged portions formed from the formed sheet-shaped green body is held on an end face of the honeycomb-shaped dried body, it is apprehended that the holding becomes unstable. However, since a plugging material is filled into cells in the present invention, it is advantageous in the point of stability in holding plugged portions.

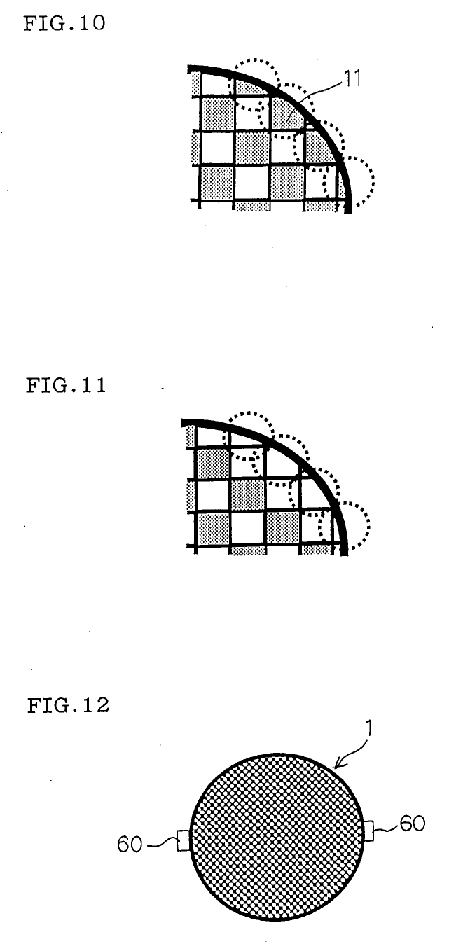

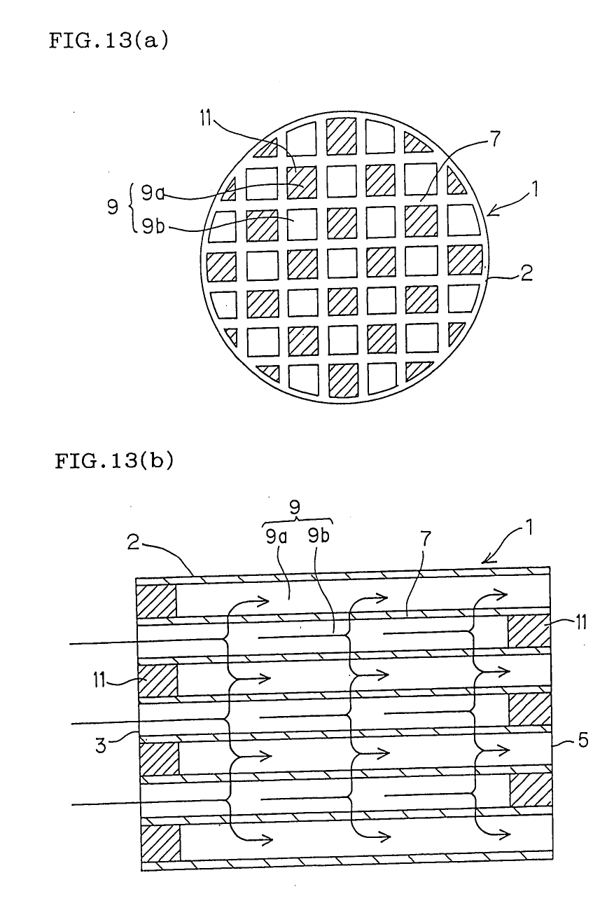

Since the cells to be plugged among the cells locating in the outermost periphery of the honeycomb structure (for example, the cells surrounded by the dotted lines in the case that a plugged honeycomb structure having plugged portions disposed so as to form a checkerwise pattern in an end face of a honeycomb structure is tried to be obtained) are entirely plugged by the plugged portions 11 as shown in FIG. 10 in the plugged honeycomb structure manufactured by a manufacturing method of the present invention, a treatment of covering opening portions of the cells locating in the outermost periphery with a ring-shaped member as described above is unnecessary even in the case that the structure is used as a filter for filtrating particulate matter or a carrier for a wall-flow type catalyst. In addition, since there is no reduction of the effective area due to the treatment, the structure exhibits high performance.

Incidentally, in the case that a structure is manufactured by a manufacturing method using a hole-making jig, as shown in FIG. 12, a structure such as a protrusion 60 or a groove serving as a standard for positioning of a honeycomb structure with respect to the hole-making jig may be formed in the outer peripheral portion of the plugged honeycomb structure 1. In addition, in a plugged honeycomb structure of the present invention, cells may be plugged by the plugged portions on only one end face.

The present invention can suitably be used as a honeycomb structure used for a filter for filtrating particulate matter such as a DPF, a carrier for a wall-flow type catalyst, or the like, and as a manufacturing method thereof.

1-14. (canceled)

15. A method for manufacturing a plugged honeycomb structure having a honeycomb structure where a plurality of cells extending between two opening ends are defined by porous partition walls and plugged portions disposed so as to plug one of the two opening ends of each of the cells,
wherein, after a plugging mixed material is filled into opening end portions of all the cells of the honeycomb structure, the plugging mixed material filled into the opening end portions of cells which should not be plugged is removed and penetrated to open the end portions of the cells which should not be plugged.

16. A method for manufacturing a plugged honeycomb structure according to claim 15, wherein an operation of removing and penetrating the plugging mixed material filled into the opening end portions of cells which should not be plugged is performed independently on each of the end faces of the honeycomb structure.

17. A method for manufacturing a plugged honeycomb structure according to claim 15, wherein the operation of removing and penetrating the plugging mixed material filled into the opening end portions of cells which should not be plugged is performed simultaneously on both the end faces of the honeycomb structure.

18. A method for manufacturing a plugged honeycomb structure having a honeycomb structure where a plurality of cells extending between two opening ends are defined by porous partition walls and plugged portions disposed so as to plug one of the two opening ends of each of the cells,
wherein, after a plugging mixed material is filled into opening end portions of all the cells of the honeycomb structures, a hole-making jig having a flat upper surface and pins disposed so as to correspond to positions of the cells which should not be plugged on an end face of the honeycomb structure is positioned so that the end portions of the cells which should not be plugged of the honeycomb structure match the positions of the pins of the hole-making jig, and the end face is pressed against the upper surface of the hole-making jig to remove and penetrate the plugging mixed material filled into the opening end portions of the cells which should not be plugged with the pins.

19. A method for manufacturing a plugged honeycomb structure according to claim 18, wherein the pins are movable on the hole-making jig, a photograph of an end face of the honeycomb structure is taken in advance and subjected to image processing to recognize positional coordinates of the cells which should not be plugged, the pins are moved based on data of the positional coordinates so that positions of the pins match positions of the cells which should not be plugged, and then the end face of the honeycomb structure is pressed against the upper surface of the hole-making jig.

20. A method for manufacturing a plugged honeycomb structure according to claim 15, wherein, after a plugging mixed material is filled into opening end portions of all the cells of the honeycomb structures, the plugging mixed material filled into the opening end portions of cells which should not be plugged is removed and penetrated by laser irradiation.

21. A method for manufacturing a plugged honeycomb structure according to claim 15, wherein, after a plugging mixed material is filled into opening end portions of all the cells of the honeycomb structures, the plugging mixed material filled into the opening end portions of cells which should not be plugged is removed and penetrated by sweeping away with pressurized fluid.

22. A method for manufacturing a plugged honeycomb structure having a honeycomb structure where a plurality of cells extending between two opening ends are defined by porous partition walls and plugged portions disposed so as to plug one of the two opening ends of each of the cells,
wherein, after a plugging mixed material is filled into opening end portions of all the cells on one end face of the honeycomb structure, the plugging mixed material filled into the opening end portions of cells which should not be plugged is removed and penetrated by sweeping away with pressurized fluid to open the end portions of the cells which should not be plugged, and then the plugging mixed material is filled into the opening end portions of the cells on the other end face of the honeycomb structure which should be plugged by vacuum suction.

23. A plugged honeycomb structure manufactured by a method according to claim 15.

24. A plugged honeycomb structure manufactured by a method according to claim 18.

25. A plugged honeycomb structure manufactured by a method according to claim 22.

26. A plugged honeycomb structure having a honeycomb structure where a plurality of cells extending between two opening ends are defined by porous partition walls and plugged portions disposed so as to plug one of the two opening ends of each of the cells, wherein the same material as a material for the plugged portions adheres to an inner peripheral face of an opening end on an unplugged side of each of the cells.

27. A plugged honeycomb structure according to claim 26, wherein the same material as a material for plugged portions further adheres to an end face of the honeycomb structure.

28. A plugged honeycomb structure according to claim 26, wherein cells which should be plugged among the cells locating in an outermost periphery of the honeycomb structure are entirely plugged with the plugged portions.

29. A plugged honeycomb structure, which is manufactured by a method for manufacturing a plugged honeycomb structure having a honeycomb structure where a plurality of cells extending between two opening ends are defined by porous partition walls and plugged portions disposed so as to plug one of the two opening ends of each of the cells, wherein, after a plugging mixed material is filled into opening end portions of all the cells of the honeycomb structures, a hole-making jig having a flat upper surface and pins disposed so as to correspond to positions of the cells which should not be plugged on an end face of the honeycomb structure is positioned so that the end portions of the cells which should not be plugged of the honeycomb structure match the positions of the pins of the hole-making jig, and the end face is pressed against the upper surface of the hole-making jig to remove and penetrate the plugging mixed material filled into the opening end portions of the cells which should not be plugged with the pins, and
a protrusion or a groove functioning as a standard for positioning is formed in an outer periphery thereof.

30. A plugged honeycomb structure according to claim 26, wherein the cells are plugged with the plugged portions on only one end face of the honeycomb structure.

31. A plugged honeycomb structure according to claim 29, wherein the cells are plugged with the plugged portions on only one end face of the honeycomb structure.

32. A plugged honeycomb structure manufactured by a method according to claim 15, wherein the cells are plugged with the plugged portions on only one end face of the honeycomb structure.

33. A plugged honeycomb structure manufactured by a method according to claim 18, wherein the cells are plugged with the plugged portions on only one end face of the honeycomb structure.

34. A plugged honeycomb structure manufactured by a method according to claim 22.
